(19) United States
(12) Patent Application Publication
(10) Pub. No.: US 2019/0152004 A1
(43) Pub. Date: May 23, 2019

(54) WORKPIECE LOCK

(71) Applicant: Liebherr-Verzahntechnik GmbH, Kempten (DE)

(72) Inventors: David HÄNSCHKE, Altusried (DE); Michael APPEL, Altusried (DE)

(21) Appl. No.: 16/194,979

(22) Filed: Nov. 19, 2018

(30) Foreign Application Priority Data
Nov. 17, 2017 (DE) 10 2017 127 184.8

(51) Int. Cl. B23Q 1/26

(52) U.S. Cl. CPC B23Q 1/26

(57) ABSTRACT

The present disclosure shows a workpiece lock for an apparatus for handling and/or machining workpieces, which includes a robot for handling and/or machining the workpieces and a safety fence, wherein the work-piece lock has at least one closed position in which the workpiece lock closes an opening in the safety fence, wherein on moving a workpiece from the area within the safety fence to the area outside the safety fence and/or vice versa the workpiece lock has at least one open position in which it at least partly clears the opening in the safety fence. The present disclosure includes a safety function that prevents a movement of the robot into a safety area extending around the workpiece lock within the safety fence, when the lock is in the at least one open position.

### CROSS REFERENCE TO RELATED APPLICATION

This application claims priority to German Patent Application No. 10 2017 127 184.8, entitled “WORKPIECE LOCK,” filed Nov. 17, 2017, the entire contents of which is hereby incorporated by reference in its entirety for all purposes.

### TECHNICAL FIELD

The present disclosure relates to a workpiece lock for an apparatus for handling and/or machining workpieces. The workpiece lock is provided for such apparatuses which include a robot for handling and/or machining the workpieces and a safety fence.

The safety fence serves to prevent operators from accessing the working area of the robot and thereby allows a safe operation of the apparatus. The workpiece lock is arranged in the safety fence and now serves to move workpieces from the area within the safety fence into an area outside the safety fence or vice versa.

### BACKGROUND AND SUMMARY

Workpiece locks for example can serve to remove workpieces from the flow of material within the safety fence for testing purposes. Alternatively or in addition, workpiece locks can be utilized as a loading and/or unloading station.

Known workpiece locks usually have at least one closed position in which they close an opening in the safety fence. In the closed position of the workpiece lock within the safety fence the robot thereby can be used without limitation.

When moving a workpiece through the workpiece lock from an area within the safety fence to an area outside the safety fence or vice versa, the workpiece lock however usually passes through an open position, which involves the risk that an operator for example puts an arm through the resulting opening and his hand thereby gets into the working area of the robot.

To prevent this from happening, mechanical solutions are known which ensure that the workpiece lock always closes the opening within the safety fence and yet allows moving of the workpieces. Such a solution is known for example from DE 20 2007 01 67 25. There are provided shiftable door elements which at least partly overlap in the loading position and the machine position so that during an opening process the one side only starts to open when the respectively other side has closed already. However, this involves a high construction effort.

Mechanical protection devices are also known from other areas. EP 1375088 B1 for example discloses a mechanical protection device in which a robot can be moved into a cylindrical protective wall in order to be pivoted to and fro between two stations, wherein the protective wall protects the one station while the robot is active at the other station.

Furthermore, from EP 1306603 B2 a method for controlling a safety-relevant function of a machine, in particular of an industrial robot, is known due to which a safety fence can be omitted. The swivel range and the position of the robot arm as well as the direction of movement and the speed of movement of the robot arm therefor are detected via a sensor. Furthermore, the position, the direction of movement and the speed of movement of a person working in the vicinity of the robot are recognized. It should thereby be ensured that robot and person never meet and persons present in the vicinity of the robot arm never are injured. For this purpose, a protective area around the robot arm is variably fixed adapted to the situation and travels along with the robot arm. When the person penetrates into the protective area, a safety-relevant function is triggered, for example the robot is switched off. However, this requires an extremely expensive detection and actuation.

It is the object of the present disclosure to provide a workpiece lock that safely prevents an operator from being injured by the robot.

According to the present disclosure, this object is solved by workpiece locks and methods described herein.

The present disclosure according to a first aspect comprises a workpiece lock for an apparatus for handling and/or machining workpieces, which includes a robot for handling and/or machining the workpieces and a safety fence, wherein the workpiece lock is arranged in the safety fence and allows to move at least one workpiece from an area within the safety fence to an area outside the safety fence and/or vice versa, wherein the workpiece lock has at least one closed position in which the workpiece lock closes an opening in the safety fence, wherein the robot includes a controller which in the closed position of the workpiece lock allows loading and/or unloading of the workpiece lock with at least one workpiece and/or machining of a workpiece moved into the area within the safety fence, and wherein on moving of a workpiece from the area within the safety fence to the area outside the safety fence and/or vice versa the workpiece lock has at least one open position in which it at least partly clears the opening in the safety fence. According to the first aspect the controller has a safety function that prevents a movement of the robot into a safety area extending around the workpiece lock within the safety fence, when the lock is in the at least one open position.

In one embodiment, a safety area is defined in the controller for the robot, which it must not enter and which it must not cross over, for the period in which the workpiece lock is in an open position.

In one embodiment, it is provided that for the case that a task provided for the robot requires moving into the safety area, for example depositing, picking up and/or machining a workpiece is imminent within the safety area, the controller stops the robot and/or moves it into a safe position, until the workpiece lock again is in a closed position. The robot need not be switched off for this purpose. The robot rather is actuated by the controller such that it stops and/or moves into a safe position.

In a further embodiment, the safety area is eliminated and the robot can again approach all positions when the workpiece lock again is in at least one closed position.

The safety area may be geometrically defined within the controller and/or stored in a memory of the controller in the form of geometric data. This provides for a simple adaptation of the safety lock to the concrete installation situation.

The controller may be configured such that it prevents movements of the robot by which the same would penetrate into the safety area. The controller matches in advance the position of at least one portion of the robot and the position and/or movement of movable elements of the robot with the geometrically defined safety area.

Due to the first aspect of the present disclosure, the robot no longer has to be switched off in order to avoid critical situations, as a movement of the robot into the safety area in the at least one open position of the lock is prevented in advance.

According to a second aspect the present disclosure comprises a workpiece lock for an apparatus for handling and/or machining workpieces, which includes a robot for handling and/or machining the workpieces and a safety fence, wherein the workpiece lock is arranged in the safety fence and allows to move at least one workpiece from an area within the safety fence to an area outside the safety fence and/or vice versa, wherein the workpiece lock has at least one closed position in which the workpiece lock closes an opening in the safety fence, wherein the robot includes a controller which in the closed position of the workpiece lock allows loading and/or unloading of the workpiece lock with at least one workpiece and/or machining of a workpiece moved into the area within the safety fence through the workpiece lock, wherein on moving of a workpiece from the area within the safety fence to the area outside the safety fence and/or vice versa the workpiece lock has at least one open position in which it at least partly clears the opening in the safety fence. According to the second aspect a safety function is provided, which monitors a safety area extending within and/or outside the safety fence around the workpiece lock via at least one sensor and performs a switch-off of the robot when an operator and/or the robot penetrates into the safety area while the lock is in the at least one open position.

In one embodiment, at least one sensor is provided that monitors a safety area extending within the safety fence around the workpiece lock, wherein the safety function performs a switch-off of the robot when the robot penetrates into the safety area while the workpiece lock is in the at least one open position.

The sensor may be is an optical sensor. One or more light barrier arrangements and/or a scanner for example can be used as a sensor.

The second aspect can also be used when the controller of the robot does not allow a realization of the first aspect.

According to both aspects of the present disclosure an injury of an operator also is prevented for the case that in the open position of the workpiece lock the operator puts an arm through the opening in the safety fence and gets in the working area of the robot.

Embodiments of the present disclosure, which relate to both aspects, will be explained in detail below:

The present disclosure may be used when the workpiece lock mechanically is configured such that in at least one open position of the workpiece lock an operator can put a body part through the opening in the safety fence into the working area of the robot.

Furthermore, the workpiece lock mechanically is configured such that even in an open position of the workpiece lock an operator cannot completely get into the area within the safety fence.

The workpiece lock can include a handle area, such as in the form of a rotary ring via which it can be moved by hand. Alternatively or in addition a drive might be provided for the workpiece lock.

The controller implementing the safety function according to the disclosure can be a robot controller, a controller external to the robot controller or a combination of both.

The controller may include a microcontroller and/or processor as well as a program code deposited in a memory including commands that implement the safety function according to the disclosure when they are carried out on the microcontroller and/or processor. The controller can be in a communication and/or control connection with sensors and/or actuators.

In an embodiment of the present disclosure the safety function or the safety area is not active when the lock is in at least one closed position.

The safety function or the safety area therefore may be active only during the period in which the workpiece lock is not in at least one closed position. In certain embodiments of the present disclosure several closed positions and/or an area of closed positions can be provided, in which the safety function and the safety area are not active.

In a possible embodiment of the present disclosure the workpiece lock comprises a sensor by which at least one open and/or closed position of the workpiece lock is detected. The sensor may be connected to the controller. With reference to the sensor the controller either is put into a safety mode, in which it operates as indicated above, or into a normal mode in which it does not intervene in the normal activity of the robot.

The sensor for example can be one or more switches that are actuated by a movement of the workpiece lock. When the workpiece lock is actuated by a drive, the sensor can also detect a position and/or movement of the drive.

In a possible embodiment of the present disclosure the workpiece lock comprises a locking device that prevents a movement of the workpiece lock into an open position as long as the operator and/or the robot is present within the safety area. Whether an operator and/or the robot is present within the safety area in a possible embodiment can be detected via a sensor, in the second aspect via the optical sensor. Alternatively or in addition, position data of the robot from the robot controller can be used to detect whether the same is present within the safety area. This solution may be used in the embodiment of the present disclosure according to the first aspect.

In a possible embodiment of the present disclosure the workpiece lock comprises a request function by which an operator can request loading or unloading of the workpiece lock with a workpiece by the robot and/or moving of the robot out of the safety area.

When the workpiece lock is an SPC lock, the request function and the workpiece lock at any time can effect a removal of a workpiece from the flow of material within the safety fence for testing purposes.

The request of moving the robot out of the safety area is advantageous independent of the intended use in order to be able to operate the workpiece lock.

In a possible embodiment of the present disclosure the workpiece lock comprises a turntable and a wall portion arranged on the turntable, which in the at least one closed position of the workpiece lock closes the opening in the safety fence and in the at least one open position at least partly clears the opening.

In a possible embodiment of the present disclosure the workpiece lock comprises a housing on the outer side of the safety fence, which reduces the area of access to the workpiece lock. When the workpiece lock includes a turntable, the housing can be designed such that it surrounds the turntable on one or on both sides of the opening around a certain angular range.

In a possible embodiment the turntable includes at least one deposition area for at least one workpiece so that by rotating the turntable a workpiece deposited on the deposition area can be moved from an area within the safety fence to an area outside the safety fence and/or vice versa. The deposition area can include at least one workpiece holder, such as a nest and/or a pin.

The turntable can be rotatable by hand and therefor may include a circumferential handle area. Alternatively or in addition the turntable can be driven, via an electric, pneumatic and/or hydraulic drive.

In a possible embodiment of the present disclosure the workpiece lock comprises at least two deposition areas for a workpiece, which can alternately be moved from an area within the safety fence to an area outside the safety fence. The turntable can include at least two deposition areas of which in a closed position of the workpiece lock one is each arranged in an area within the safety fence and the other one is arranged in an area outside the safety fence.

When two deposition areas are provided, the same are separated from each other by the wall portion of the workpiece lock, which in the closed position closes the opening in the safety fence.

The deposition area or the deposition areas can also include a plurality of workpiece deposits. This is advantageous for example when using small parts or a double gripper. As a result, several workpieces can be discharged and/our introduced at the same time.

The deposition area or areas may be arranged on a turntable.

In a possible embodiment of the present disclosure it is provided that within the safety fence, but outside the safety area, at least one first deposition area independent of the workpiece lock is present for at least one workpiece, wherein the controller allows loading and/or unloading of the first deposition area with a workpiece and/or machining of a workpiece in the first deposition area, while the workpiece lock is in the at least one open position.

Even with an open workpiece lock, the work within the safety fence thereby can be continued.

In a possible embodiment of the present disclosure it is provided that within the safety fence at least one second deposition area independent of the workpiece lock is present for at least one workpiece, which is arranged in the safety area. This may be inevitable for reasons of space.

A process controller may be provided that plans the activity of the robot in an automated way, wherein the process controller exclusively performs loading and/or unloading of a first deposition area with a workpiece and/or the machining of a workpiece in a first deposition area and/or excludes loading and/or unloading of the second deposition area with a workpiece and/or the machining of a workpiece in the second deposition area as long as the workpiece lock is in the at least one open position.

Due to a corresponding process control it thereby becomes already less probable that without the safety functions according to the present disclosure the robot would penetrate into the safety area during its activity so that said safety functions intervene less frequently.

When a first and a second deposition area are provided for a workpiece, as they have been described above, it may be provided that the same are usable in parallel with the same function with regard to the flow of material within the safety fence.

The process control may be designed such that it provides loading and/or unloading both of the first and of the second deposition area with a workpiece and/or machining of a workpiece both in the first and in the second deposition area as long as the workpiece lock is in a closed position.

In a possible embodiment of the present disclosure the workpiece lock allows a removal and/or recirculation of workpieces from and/or into the flow of material within the safety fence for testing purposes. This can be an SPC lock.

In a possible embodiment of the present disclosure it allows loading and/or unloading of a flow of material provided within the safety fence with workpieces. The workpiece lock hence can be a loading and/or unloading station.

In a possible embodiment of the present disclosure the robot has a robot arm, wherein it may be a 6-axes industrial robot.

Alternatively or in addition, the robot can comprise an area and/or linear gantry.

In a possible embodiment of the present disclosure the robot includes a gripper for handling the workpieces and/or a tool for machining the workpieces. The gripper may be a mechanical, pneumatic and/or magnetic gripper. The gripper can be provided for gripping one or more workpieces.

The present disclosure furthermore comprises an apparatus for handling and/or machining a workpiece with a safety fence, a robot arranged within a safety fence, and a workpiece lock arranged in the safety fence, as it has been described above.

Furthermore, the present disclosure comprises a method for operating an apparatus according to the present disclosure, with the following steps:
loading and/or unloading of the workpiece lock with at least one workpiece while the workpiece lock is in the closed position, and
moving the workpiece from the area within the safety fence to the area outside the safety fence and/or vice versa by actuation of the workpiece lock, which here has at least one open position in which it at least partly clears the opening in the safety fence.

According to the first aspect the method includes preventing a movement of the robot into a safety area extending around the workpiece lock within the safety fence the controller of the robot when the lock is in the at least one open position. According to the second aspect the method includes a safety area extending within and/our outside the safety fence around the workpiece lock is monitored via at least one sensor and a switch-off of the robot is performed when an operator and/or the robot penetrates into the safety area while the lock is in the at least one open position.

In an embodiment, the method is effected such as this has already been described above in detail.

In an embodiment, the actuation of the robot according to the present disclosure and/or the implementation of the safety functions according to the present disclosure is effected by a controller in an automated way. The present disclosure will now be explained in detail with reference to exemplary embodiments and drawings.

### BRIEF DESCRIPTION OF THE FIGURES

FIG. 1 shows a first exemplary embodiment of an apparatus according to the present disclosure for handling or machining workpieces with a first exemplary embodiment of a workpiece lock according to the present disclosure.

FIG. 2A shows the first exemplary embodiment of a workpiece lock in a view from outside the safety fence, in a first open position at an angle of rotation of 45°.

FIG. 2B shows the first exemplary embodiment of a workpiece lock in a view from within the safety fence, in the first open position at an angle of rotation of 45°.

FIG. 3A shows the first exemplary embodiment of a workpiece lock according to the present disclosure in a view from outside the safety fence, in a second open position at an angle of rotation of 90°.

FIG. 3B shows the first exemplary embodiment of a workpiece lock in a view from within the safety fence, in the second open position at an angle of rotation of 90°.

FIG. 4 shows a second exemplary embodiment of an apparatus for handling and/or machining workpieces with a second exemplary embodiment of a workpiece lock according to the present disclosure.

### DETAILED DESCRIPTION

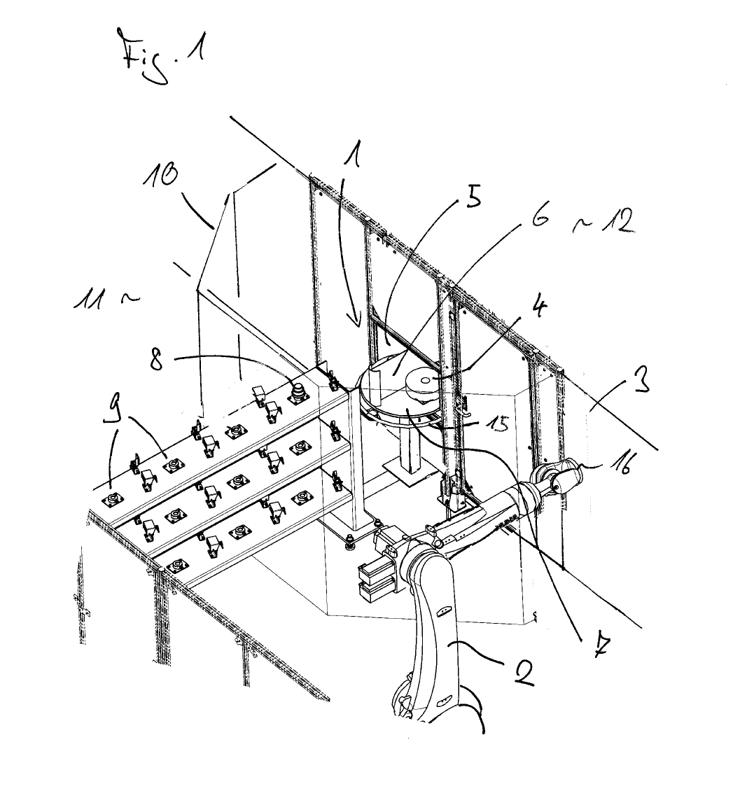

FIG. 1 shows a first exemplary embodiment of an apparatus according to the present disclosure for handling and/or machining workpieces with a first exemplary embodiment of a workpiece lock 1 according to the present disclosure.

Beside the workpiece lock 1 the apparatus according to the present disclosure includes a robot 2 for handling and/or machining workpieces 4 as well as a safety fence 3 that surrounds the working area of the robot 2. The safety fence 3 prevents that operators have unauthorized access to the working area of the robot 2 and thereby are exposed to injuries by the robot. The safety fence 3 for example can consist of corresponding cell walls and/or wall portions. The apparatus according to the present disclosure can be a robot cell.

In the exemplary embodiment a gripper 16 is arranged on the robot 2, by which workpieces 4 can be gripped and handled. In the exemplary embodiment a plurality of workpiece deposits 8 and 9 are provided within the safety fence 3, on which the robot 2 can deposit workpieces and/or from which the robot can remove workpieces. In the exemplary embodiment, the workpiece lock serves the removal of workpieces 4 from the flow of material within the safety fence, possibly for testing purposes. The workpieces therefor are deposited by the robot on a workpiece deposit of the workpiece lock. The workpiece lock then allows a removal of the workpiece from the area within the safety fence into an area outside the safety fence, for example in order to test the workpiece in conjunction with quality control measures.

Furthermore, the workpiece lock allows a reintroduction of the workpiece from outside the safety fence into an area within the safety fence. The robot 2 therefore can grip a workpiece 4 from the workpiece deposit of the workpiece lock and put it back into the flow of material within the safety fence.

In the same way, however, the workpiece lock according to the present disclosure also might be used for loading or unloading a machine environment arranged within the safety fence. In this case, too, the robot 2 can be a handling robot with a gripper 16.

Furthermore, it is conceivable that the robot 2 is a machining robot that carries a tool.

In the exemplary embodiment, a 6-axes industrial robot is used as robot 2. According to the present disclosure, however, any other robots can also be used, for example linear and/or area gantries.

The workpiece lock 1 according to the present disclosure is arranged in the safety fence 3 which includes an opening 5 in the vicinity of the workpiece lock 1. The workpiece lock 1 has a wall portion 6 which in at least one closed position of the workpiece lock closes the opening 5. In this closed position, the wall portion of the workpiece lock therefore prevents that an operator might reach through the workpiece lock into the working area of the gripper of the robot 2. In the closed position, the robot 2 therefore can deposit for example a workpiece 4 on a workpiece deposit of the workpiece lock and otherwise also is free in its activity.

By actuating the workpiece lock 1 the workpiece on the workpiece holder of the workpiece lock can then be moved from the area within the safety fence into an area outside the safety fence, where it can be removed by an operator. The wall portion 6 of the workpiece lock however at least partly clears the opening 5 during this movement of the workpiece lock in at least one open position. During this period, there is therefore a risk that an operator for example moves a hand or an arm through the opening 5 in the safety fence 3 into the area within the safety fence and hence into the working area of the robot 2.

To safely prevent an injury of the operator, the workpiece lock according to the present disclosure therefore has a safety function.

According to a first aspect of the present disclosure this safety function prevents a movement of the robot into a safety area 10 extending within the safety fence and the workpiece lock, when the workpiece lock 1 is in an open position. The safety function is implemented in the controller of the robot 2 and is activated when the lock is moved from a closed position into an open position. The corresponding safety area 10 therefor may be stored in the controller of the robot 2.

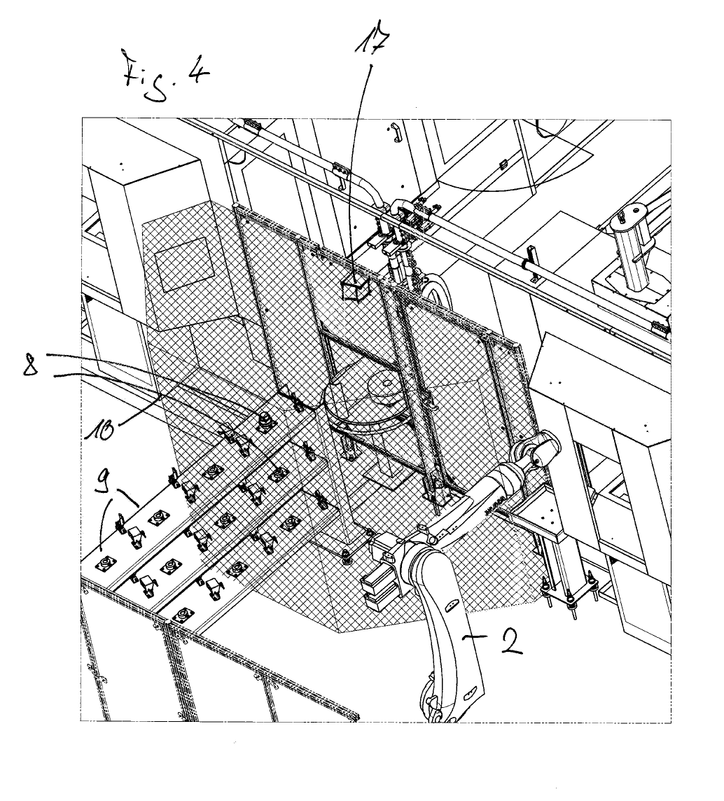

According to a second aspect of the present disclosure, which is shown in detail in FIG. 4, the safety function monitors a safety area 10 extending within and/or outside the safety fence around the workpiece lock via at least one sensor 17 and performs a switch-off of the robot 2 when an operator and/or robot penetrates into the safety area 10 and the lock is in the at least one open position. Here as well, the safety function therefore is activated only when the lock 1 is moved from a closed into an open position.

With regard to its mechanical construction, the first and the second exemplary embodiment of the workpiece lock according to the present disclosure are identically constructed. This mechanical design of the workpiece lock according to the present disclosure as used in the exemplary embodiments will now be described in detail below with reference to FIGS. 1 to 4.

The workpiece lock 1 according to the present disclosure includes a turntable 7 which is disposed partly within and partly outside the safety fence and extends through the opening 5 of the safety fence 3. On the turntable 7 the wall portion 6 is arranged, which in a closed position closes the opening 5 in the safety fence 3. The wall portion 6 at the same time serves as a dividing wall between two deposition areas on the turntable 7. Both deposition areas have a workpiece deposit 13, 13′ on which a workpiece 4 can each be deposited. In an alternative embodiment, the deposition areas 7 also might each include two or more workpiece deposits, for example when small workpieces are handled and/or a multiple gripper is used.

The workpiece lock in general has two closed positions in which the wall portion 6 closes the opening 5. In the one position the first workpiece deposit 13 is arranged outside the safety fence and the second workpiece deposit 13′ is arranged within the safety fence; in the second closed position the arrangement is exactly the opposite. The workpiece lock can be moved from the one closed position into the other closed position by rotating the turntable 7 by 180°. The two workpiece deposits 13 and 13′ thereby switch their positions so that a workpiece can be moved from within the safety fence to the outside and at the same time a workpiece can be moved from outside the safety fence into the area within the safety fence.

In the illustrated exemplary embodiment the workpiece lock according to the present disclosure therefore allows the simultaneous discharge and introduction of a workpiece. In alternative aspects of the present disclosure it is likewise conceivable, however, that the workpiece lock includes merely one of the workpiece holders 13 or 13′ and/or with one channeling operation provides for merely the discharge or merely the introduction of a workpiece.

In the exemplary embodiment the workpiece lock includes a rotary ring 15 via which it can be moved by hand. Alternatively, a drive might be provided for the workpiece lock, by which the same can be moved from the first closed position into the second closed position and back.

On the outer side of the safety fence the workpiece lock has a housing 14 which reduces the area of access to the workpiece lock. The area left open by the housing 14 is smaller than the opening 5 in the safety fence.

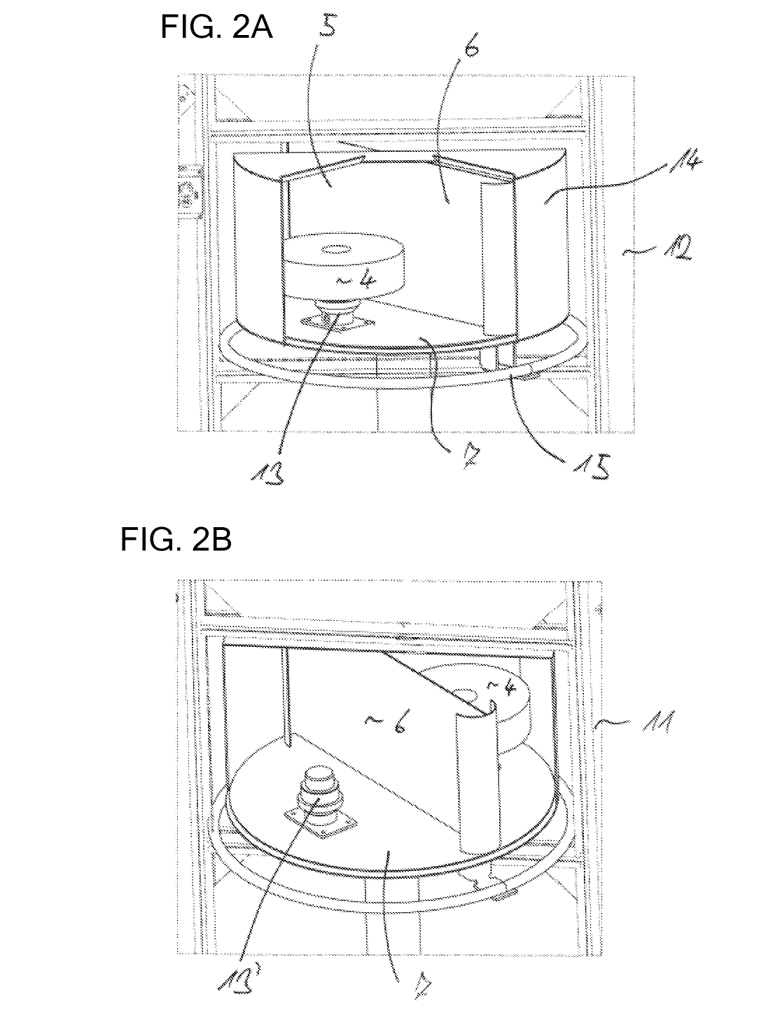

In the exemplary embodiment the housing 14 is designed such that it surrounds the turntable 7 on both sides of the opening 5 around a certain angular range. The dividing wall 6 therefore clears the opening 5 at least on one side only after a certain rotary movement. This is shown for example in FIG. 2A at a position of 45° of the turntable from the closed position, as the dividing wall 6 here still terminates with the housing 14, and reaching through the opening 5 therefore is not possible on the right side.

In the embodiment of FIG. 2B, however, no corresponding housing is provided on the inside. On the other side, reaching through the opening 5 therefore is possible already in this position. In alternative embodiments, however, it would likewise be conceivable to provide a corresponding housing also on the inside, so that a whole range of closed positions of the workpiece locks would be obtained or the range of the open positions would be reduced.

Due to the mechanical design, reaching through the workpiece lock already is made difficult by the housing. Such a mechanical safety function however is not absolutely necessary in accordance with the present disclosure, as the safety function of the controller according to the present disclosure safely prevents an injury of an operator.

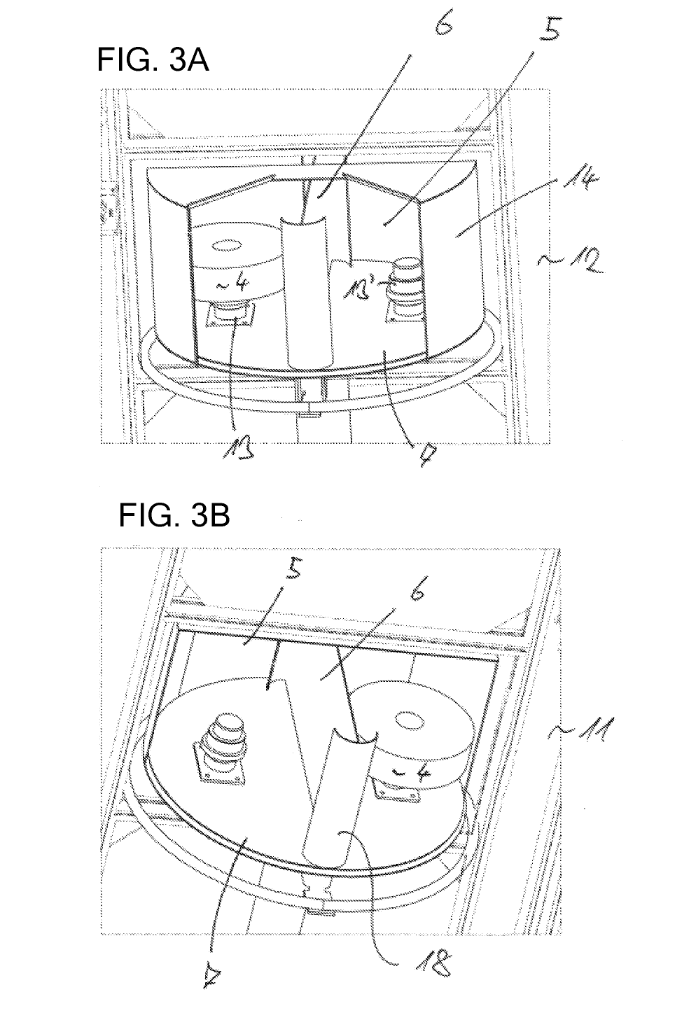

In FIGS. 3A and 3B the workpiece lock now is shown in a position rotated by 90° with respect to the closed position, in which reaching through the opening 5 is possible on both sides of the dividing wall 6.

In the exemplary embodiment the wall portion 6 of the workpiece lock each has rounded end portions 18 which are meant to reduce the risk of injury by pinching fingers between the wall portion 6 and the housing 14 or between the edges of the opening 5 of the safety fence when rotating the turntable.

In the exemplary embodiment the apparatus according to the present disclosure operates as follows:

When the workpiece lock 1 is in a closed position, a workpiece 4 can be requested so that the workpiece deposit 13 or 13′, which is disposed on the inside of the safety fence 3, can be loaded with the workpiece 4 by the robot 2. The apparatus therefor has a request function that can be actuated by an operator so that the robot removes a workpiece from the flow of material and deposits the same on the workpiece deposit of the workpiece lock. In the closed position of the workpiece lock reaching into the robot cell is not possible, as the wall portion 6 of the workpiece lock closes the opening 5 in the safety fence 3.

Discharging the workpiece is effected by rotating the turntable, in the present case by rotating the turntable 7 via the handle bar. The workpiece deposited on the workpiece deposit 13, 13′ thereby is moved to the outside.

After a rotation of the turntable by 180°, the workpiece can be removed from outside. In this position, too, the opening 5 is closed by the wall portion 6 of the workpiece lock 1 so that reaching through the workpiece lock into the robot cell is not possible.

At the same time, a further workpiece deposit is provided within the safety fence, which might be loaded by the robot. For this purpose as well a corresponding request function is provided.

For reintroduction purposes the workpiece, for example after having carried out a test, can again be put onto a workpiece deposit 13, 13′ of the turntable on the outside and can be introduced again by rotating. At the same time—when the turntable has meanwhile been loaded on the inside—another workpiece can be discharged.

In the two closed positions there is therefore no safety risk, so that the robot can work within the safety fence without any restriction. During the rotary movement, however, the opening 5 is at least partly cleared so that an operator might reach into the robot cell.

To be able to nevertheless safely avoid an injury of the operator, a safety area 10, into which the robot must not enter or which it must not cross, is defined for the robot in the safety function according to the first aspect of the present disclosure for the period in which the workpiece lock is open. When the robot wants to deposit a workpiece within the safety area in this period, for example on a workpiece deposit 8 arranged within the safety area, it will stop until the workpiece is discharged and the workpiece lock again is in a closed position, for example in that the rotation by 180° is completed.

When the workpiece lock again is in a closed position, for example in that the turntable is rotated by 0° or 180° and the wall portion 6 closes the opening 5, the safety area again is eliminated and the robot can again approach all positions. The safety area hence is active only during the period in which the workpiece lock is open, i.e. in the time that is required for rotating the turntable.

The safety area 10 may be defined within the robot controller and is taken into account by the robot controller when the safety function is activated. The safety area can be defined geometrically.

In a safety function according to the second aspect, on the other hand, a sensor 17 is provided in the exemplary embodiment shown in FIG. 4, which monitors a safety area 10 arranged within the safety fence around the workpiece lock. This safety function also is activated only when the workpiece lock is in an open position and is deactivated when the workpiece lock is in a closed position.

According to the second aspect, the safety area is monitored by the sensor 17 as to whether the robot 2 penetrates into the safety area 10. When this is recognized while the safety function is active, the robot is switched off. Such a solution can therefore also be implemented when the robot controller itself does not provide for the definition of a safety area. However, it has the disadvantage that on the one hand an additional sensor is required and on the other hand a switch-off of the robot 2 is accepted. According to the first aspect, however, such a switch-off of the robot can reliably be prevented, as the safety area is defined within the robot controller.

As shown in FIG. 4, the sensor 17 for example can be a scanner arranged in the region above the workpiece lock, which monitors the safety area 10. Alternatively or in addition, the use of light barriers for generating a monitored safety area would be conceivable.

Independent of which aspect of the present disclosure will be used, the workpiece lock may include a sensor by which a closed and/or open position of the workpiece lock is recognized and via whose signal the safety function is activated or deactivated.

To be able to continue to operate the flow of material within the safety fence without any interruption even with an open workpiece lock, a superordinate process controller furthermore can be provided, which takes account of the safety area already in the process planning stage.

When, as shown in the exemplary embodiments in FIGS. 1 and 4, both first workpiece holders 13 are provided, which lie outside the safety area, and second workpiece holders 13′, which lie within the safety area 10, the process control plans the activity of the robot 2 such that with an activated safety function or in the case of an imminent opening of the lock the robot 2 only picks up workpieces from the first workpiece deposits 9 or puts them down on the same. The probability that the robot will penetrate or penetrates into the safety area 10 thereby is reduced by the tasks assigned to it.

A corresponding process control can be triggered for example via the request function. After the deposition of a workpiece on the workpiece lock triggered by the request function, the robot 2 therefore may be only used to deposit or pick up or machine workpieces on the workpiece deposits 9, which lie outside the safety area 10, until the workpiece is discharged and the workpiece lock again is in a closed position.

Alternatively or in addition, the request function furthermore can effect that after the deposition of a workpiece on the workpiece lock the robot moves out of the safety area 10.

The workpiece lock furthermore may have a locking function which only allows opening of the workpiece lock when the robot 2 is outside the safety area 10.

In the exemplary embodiments shown in FIGS. 1 to 4, the workpiece lock is an SPC lock (Statistical Process Control) by which workpieces can be removed from the flow of material for testing purposes. The workpiece lock according to the present disclosure can, however, also be utilized for any other intended uses.

1. A workpiece lock for an apparatus for handling and/or machining workpieces, which includes a robot for handling and/or machining the workpieces and a safety fence,
wherein the workpiece lock is arranged in the safety fence and allows to move at least one workpiece from an area within the safety fence to an area outside the safety fence and/or vice versa,
wherein the workpiece lock has at least one closed position in which the workpiece lock closes an opening in the safety fence, wherein the robot includes a controller which in the closed position of the workpiece lock allows loading and/or unloading of the workpiece lock with at least one workpiece and/or machining of a workpiece moved through the workpiece lock into the area within the safety fence,
wherein on moving of a workpiece from the area within the safety fence to the area outside the safety fence and/or vice versa the workpiece lock has at least one open position in which it at least partly clears the opening in the safety fence, wherein the controller has a safety function which prevents a movement of the robot into a safety area extending around the workpiece lock within the safety fence, when the lock is in the at least one open position.

2. The workpiece lock according to claim 1, wherein for the case that a task provided for the robot including depositing, picking up and/or machining a workpiece requires a movement into the safety area, the controller stops the robot and/or moves it into a safe position until the workpiece lock again is in a closed position.

3. A workpiece lock for an apparatus for handling and/or machining workpieces, which includes a robot for handling and/or machining the workpieces and a safety fence,
wherein the workpiece lock is arranged in the safety fence and allows to move at least one workpiece from an area within the safety fence to an area outside the safety fence and/or vice versa,
wherein the workpiece lock has at least one closed position in which the workpiece lock closes an opening in the safety fence, wherein the robot includes a controller which in the closed position of the workpiece lock allows loading and/or unloading of the workpiece lock with at least one workpiece and/or machining of a workpiece moved through the workpiece lock into the area within the safety fence,
wherein on moving a workpiece from the area within the safety fence to the area outside the safety fence and/or vice versa the workpiece lock has at least one open position in which it at least partly clears the opening in the safety fence, a safety function is provided, which monitors a safety area extending around the workpiece lock within and/our outside the safety fence via at least one sensor and performs a switch-off of the robot when an operator and/or the robot penetrates into the safety area while the lock is in the at least one open position.

4. The workpiece lock according to claim 1, wherein the safety function is not active when the lock is in at least one closed position.

5. The workpiece lock according to claim 1, comprising at least one sensor by which at least one open and/or closed position of the workpiece lock is detected, and/or comprising a locking device that prevents a movement of the workpiece lock into an open position as long as the operator and/or the robot is within the safety area.

6. The workpiece lock according to claim 1, comprising a request function by which an operator can request loading or unloading of the workpiece lock with a workpiece by a robot and/or moving of the robot out of the safety area.

7. The workpiece lock according to claim 1, comprising a turntable and a wall portion arranged on the turntable, which in the at least one closed position of the workpiece lock closes the opening in the safety fence.

8. The workpiece lock according to claim 7, wherein the turntable includes at least one deposition area for at least one workpiece so that by rotating the turntable a workpiece deposited on the deposition area can be moved from an area within the safety fence to an area outside the safety fence and/or vice versa, wherein the deposition area includes a workpiece holder of a nest and/or a pin.

9. The workpiece lock according to claim 1, wherein the workpiece lock comprises at least two deposition areas for a workpiece, which can alternately be moved from an area within the safety fence to an area outside the safety fence.

10. The workpiece lock according to claim 1, wherein within the safety fence, but outside the safety area at least one first deposition area independent of the workpiece lock is provided for at least one workpiece, wherein the controller allows loading and/or unloading of the first deposition area with a workpiece and/or machining of a workpiece in the first deposition area while the workpiece lock is in the at least one open position, and/or wherein within the safety fence at least one second deposition area independent of the workpiece lock is present for at least one workpiece, which is arranged in the safety area, wherein the first and the second deposition area are usable in parallel with the same function with regard to the flow of material within the safety fence.

11. The workpiece lock according to claim 10, comprising a process controller that plans the activity of the robot in an automated way, wherein the process controller exclusively performs loading and/or unloading of a first deposition area with a workpiece and/or the machining of a workpiece in a first deposition area and/or excludes loading and/or unloading of the second deposition area with a workpiece and/or the machining of a workpiece in the second deposition area as long as the workpiece lock is in the at least one open position.

12. The workpiece lock according to claim 1, wherein the workpiece lock allows a removal and/or recirculation of workpieces from and/or into the flow of material within the safety fence for testing purposes, and/or wherein the workpiece lock allows loading and/or unloading of a flow of material provided within the safety fence with workpieces.

13. The workpiece lock according to claim 1, wherein the robot includes a robot arm and/or wherein the robot comprises an area and/or linear gantry, and/or wherein the robot includes a gripper for handling the workpieces and/or a tool for machining the workpieces.

14. An apparatus for handling and/or machining a workpiece with a safety fence, a robot arranged within a safety fence and a workpiece lock arranged in the safety fence according to claim 1.

15. A method for operating an apparatus according to claim 14, with the following steps:
loading and/or unloading of the workpiece lock with at least one workpiece while the work-piece lock is in the closed position, and
moving the workpiece from the area within the safety fence to the area outside the safety fence and/or vice versa by actuation of the workpiece lock, which here has at least one open position in which it at least partly clears the opening in the safety fence,
wherein a movement of the robot into a safety area extending around the workpiece lock within the safety fence is prevented by the controller of the robot when the lock is in the at least one open position,
and/or that a safety area extending around the workpiece lock within and/our outside the safety fence is monitored via at least one sensor and a switch-off of the robot is performed when an opera-tor and/or the robot penetrates into the safety area while the lock is in the at least one open position.

16. A method for operating an apparatus for handling a workpiece with a safety fence,
handling or machining workpieces using an apparatus including a workpiece lock, a robot and a safety fence, the robot and the workpiece lock positioned within the safety fence
moving at least one workpiece from an area within the safety fence to an area outside the safety fence and/or vice versa,
loading and/or unloading of the workpiece lock with at least one workpiece while the work-piece lock is in the closed position, and
moving the workpiece from the area within the safety fence to the area outside the safety fence and/or vice versa by actuation of the workpiece lock, the workpiece lock having at least one open position in which it at least partly clears the opening in the safety fence,
preventing a movement of the robot into a safety area extending around the workpiece lock within the safety fence using the controller of the robot when the lock is in the at least one open position,
and/or monitoring a safety area extending around the workpiece lock within and/or outside the safety fence via at least one sensor and switching off the robot when an operator and/or the robot penetrates into the safety area while the lock is in the at least one open position.

17. The workpiece lock according to claim 1, wherein the robot includes a 6-axes industrial robot, and/or wherein the robot comprises an area and/or linear gantry, and/or wherein the robot includes a gripper for handling the workpieces and/or a tool for machining the workpieces.

18. The workpiece lock according to claim 3, wherein the safety function is not active when the lock is in at least one closed position.

19. The workpiece lock according to claim 3, comprising a turntable and a wall portion arranged on the turntable, which in the at least one closed position of the workpiece lock closes the opening in the safety fence, wherein the turntable includes at least one deposition area for at least one workpiece so that by rotating the turntable a workpiece deposited on the deposition area can be moved from an area within the safety fence to an area outside the safety fence and/or vice versa, wherein the deposition area includes a workpiece holder of a nest and/or a pin.

20. The workpiece lock according to claim 3, wherein within the safety fence, but outside the safety area at least one first deposition area independent of the workpiece lock is provided for at least one workpiece, wherein the controller allows loading and/or unloading of the first deposition area with a workpiece and/or machining of a workpiece in the first deposition area while the workpiece lock is in the at least one open position, and/or wherein within the safety fence at least one second deposition area independent of the workpiece lock is present for at least one workpiece, which is arranged in the safety area, wherein the first and the second deposition area are usable in parallel with the same function with regard to the flow of material within the safety fence.
